(19) United States
(12) Patent Application Publication
(10) Pub. No.: US 2018/0239621 A1
(43) Pub. Date: Aug. 23, 2018

(54) METHOD AND DEVICE OF OPERATING FUNCTIONAL MODULE CROSS PLATFORMS

(71) Applicant: PAX COMPUTER TECHNOLOGY (SHENZHEN) CO., LTD., Shenzhen, Guangdong (CN)

(72) Inventors: Lihong XIE, Shenzhen, Guangdong (CN); Renchi ZHENG, Shenzhen, Guangdong (CN); Xin LI, Shenzhen, Guangdong (CN)

(73) Assignee: PAX COMPUTER TECHNOLOGY (SHENZHEN) CO., LTD., Shenzhen, Guangdong (CN)

(21) Appl. No.: 15/551,840

(22) PCT Filed: Nov. 17, 2016
(86) PCT No.: PCT/CN2016/106260

§ 371 Date: Aug. 17, 2017

(30) Foreign Application Priority Data
Jul. 25, 2016 (CN) 201610593862.9

(51) Int. Cl. G06F 9/445; G06F 8/54; H04L 9/30; H04L 9/32; G06F 9/54

(52) U.S. Cl. CPC G06F 9/44557; G06F 8/54; G06F 9/54; H04L 9/3249; G06F 9/44589; H04L 9/302

(57) ABSTRACT

A method of operating a functional module across platforms is proposed, the method includes: obtaining a source code of the functional module, the source code of the functional module being a standard C code; compiling the source code to generate a plurality of intermediate files; link processing the plurality of intermediate files to generate an object file; loading the object file; and allocating a memory space for a bytecode in the object file and dividing the bytecode into a code segment and a data segment running in the memory space. The method implements isolation between the functional module and the platform during the whole process, which can implement of operating a functional module cross platforms without any modification of the functional module, so that the operation is simple. Further, a device of operating a functional module across platforms is also proposed.

### FIELD OF THE INVENTION

The present invention relates to the field of computer processing, and particularly to a method and a device of operating a functional module across platforms.

### BACKGROUND OF THE INVENTION

The functional modules of processing card data during transaction are generally present in the POS terminal system. Such functional modules usually comply with the uniform protocol standard, which is not related to the system platform and the programming language from the application logic and algorithm processing, such as, the payment protocol modules of the contact card and the non-contact card and the like. However, such modules need to be programmed and developed for the system in different terminal system platforms to implement the same functions or protocol standards, and need to submit certifications respectively, so that the process is very troublesome.

### SUMMARY OF THE INVENTION

Accordingly, it is necessary to provide a method and a device of operating a functional module across platforms, which can be operated simply.

A method of operating a functional module across platforms, the method includes the steps of: obtaining a source code of the functional module, the source code of the functional module being a standard C code; compiling the source code to generate a plurality of intermediate files; link processing the plurality of intermediate files to generate an object file; loading the object file; and allocating a memory space for a bytecode in the object file and dividing the bytecode into a code segment and a data segment running in the memory space.

In an embodiment, after the step of allocating the memory space for the bytecode in the object file and dividing the bytecode into the code segment and the data segment running in the memory space; the method further includes: receiving a command of calling an API function in the object file; interpreting the command by an interpreter and calling the API function in the object file by the interpreter to execute the command; and indirectly calling a function in a host system by a system call mechanism of a virtual machine when the object file needs to call the function in the host system.

In an embodiment, prior to the step of loading the object file, the method further includes: extracting a file identifier in the object file; and verifying whether the object file is valid or not according to the file identifier; if yes, loading the object file.

In an embodiment, after the step of link processing the plurality of intermediate files to generate the object file; the method further includes: encrypting the object file by using an RSA encryption algorithm; the RSA encryption algorithm comprising a public key and a private key; wherein signing the object file by using the private key in RSA, and verifying a signature of the object file by using the public key in RSA.

In an embodiment, the method further includes: controlling an authority of the object file to access a function in a host system, so that the object file can only access an open function in the host system through a virtual machine.

A device of operating a functional module across platforms, the device includes: an obtainment module configured to obtain a source code of the functional module, the source code of the functional module being a standard C code; a compilation module configured to compile the source code to generate a plurality of intermediate files; a link module configured to link process the plurality of intermediate files to generate an object file; a loading module configured to loading the object file; an allocation module configured to allocate a memory space for a bytecode in the object file and dividing the bytecode into a code segment and a data segment running in the memory space.

In an embodiment, the device further includes: a reception module configured to receive a command of calling an API function in the object file; an execution module configured to parse the command by an interpreter and call the API function in the object file by the interpreter to execute the command; and a call module configured to indirectly call a function in a host system by a system call mechanism of a virtual machine when the object file needs to call the function in the host system.

In an embodiment, the device further includes: an extraction module configured to extract a file identifier in the object file; and a verification module configured to verify whether the object file is valid or not according to the file identifier; if yes, the loading module is informed to load the object file.

In an embodiment, the device further includes: an encryption module configured to encrypt the object file by using an RSA encryption algorithm; the RSA encryption algorithm comprising a public key and a private key; wherein the object file is signed by using the private key in RSA, and a signature of the object file is verified by using the public key in RSA.

In an embodiment, the device further includes: a control module configured to control an authority of the object file to access a function in a host system, so that the object file can only access an open function in the host system through a virtual machine.

The above method and device of operating a functional module across platforms obtain a source code of the functional module, the source code of the functional module being a standard C code; compile the source code to generate a plurality of intermediate files; link process the plurality of intermediate files to generate an object file; load the object file; and allocate a memory space for a bytecode in the object file and divide the bytecode into a code segment and a data segment running in the memory space. The method implements isolation between the functional module and the platform during the whole process, which can implement operation of a functional module cross platforms without any modification of the functional module, so that the operation is simple.

### BRIEF DESCRIPTION OF THE DRAWINGS

FIG. 1 is an inner schematic diagram of a terminal in an embodiment;

FIG. 2 is a flow chart of a method of operating a functional module across platforms in an embodiment;

FIG. 3 is a schematic diagram of a method of compiling and linking the source code to generate the object file in an embodiment;

FIG. 4 is a flow chart of operating a functional module across platforms through a virtual machine in an embodiment;

FIG. 5 is a flow chart of a method of operating a functional module across platforms in another embodiment;

FIG. 6 is a flow chart of a method of operating a functional module across platforms in yet another embodiment;

FIG. 7 is a schematic diagram of working process of an interpreter in the virtual machine in an embodiment;

FIG. 8 is a flow chart of a method of operating a functional module across platforms in another embodiment;

FIG. 9 is a block diagram of a device of operating a functional module across platforms in an embodiment;

FIG. 10 is a block diagram of a device of operating a functional module across platforms in another embodiment;

FIG. 11 is a block diagram of a device of operating a functional module across platforms in yet another embodiment;

FIG. 12 is a block diagram of a device of operating a functional module across platforms in another embodiment; and

FIG. 13 is a block diagram of a device of operating a functional module across platforms in another embodiment.

### DETAILED DESCRIPTION OF THE EMBODIMENTS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

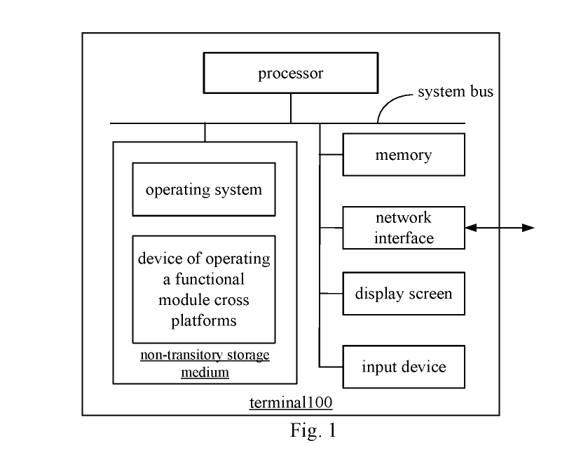

Referring to FIG. 1, in an embodiment, the inner structure of the terminal 100 is shown in FIG. 1. The terminal 100 includes a processor, a memory, a non-transitory storage medium, a network interface, a display screen, and an input device connected via a system bus; wherein the non-transitory storage medium of the terminal 100 stores an operating system and further includes a device of operating a functional module across platforms. The device of operating a functional module across platforms is configured to implement a method of operating a functional module across platforms. The processor is configured to provide computing and control capabilities to support operation of the entire terminal. The memory in the terminal provides an environment for operation of the device of operating a functional module across platforms in the non-transitory storage medium, and the memory may store computer readable instructions which, when executed by the processor, may enable the processor to perform the method of operating a functional module across platforms. The network interface is configured to connect to the network for communication, such as transmitting the obtained information of the bank card to the bank server and the like. The display screen of the terminal may be a liquid crystal display screen or an electronic ink display screen and the like. The input device may be a touch layer covering on the display screen or a button, a card slot, a trackball or a touch panel provided on the housing of the electronic device. The input device can also be an external keyboard, touchpad or mouse and the like. The terminal can be a POS machine, a mobile phone, a tablet computer, or a personal digital assistant or a wearable device and the like. It will be understood by those skilled in the art that the structure shown in FIG. 1 is merely a block diagram of a partial structure related to the present solution and does not constitute a limitation on the terminal to which the present solution is applied, and a specific terminal may include more or less parts shown in the drawings, or may combine certain parts, or may an arrangement of different parts.

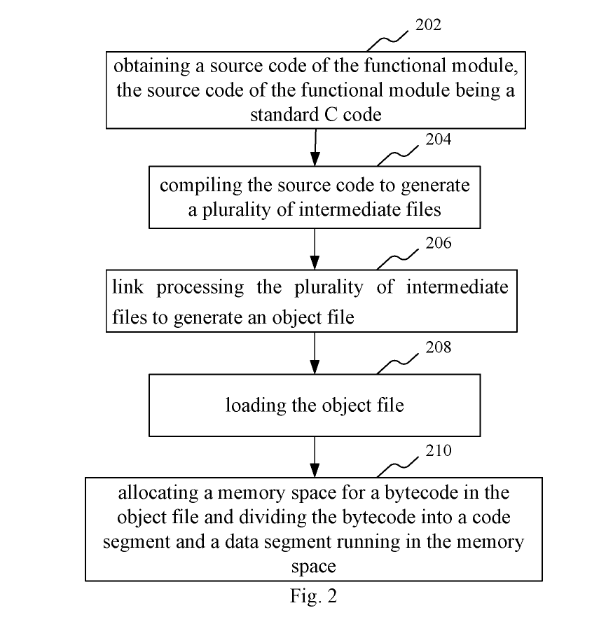

Referring to FIG. 2, in an embodiment, a method of operating a functional module across platforms is proposed. The method includes the following steps:

In step 202, a source code of the functional module is obtained, and the source code of the functional module is a standard C code.

In the embodiment, in order to implement the functional module cross platforms of, a virtual machine of implementing the functional module cross platforms is developed by using C language. The functional module is programmed by using the standard C, that is to say, the source code of the functional module is the standard C code. Firstly, the source code of the functional module is obtained by using the compiler supporting the C language virtual machine and the source code is compiled.

In step 204, the source code is compiled to generate a plurality of intermediate files.

In the embodiment, the source code is compiled by using the compiler supporting the C language virtual machine to generate a plurality of intermediate files; wherein, the compiler is a program that translates a language (usually a high level language) into another language (usually a low level language). Particularly, the C code is compiled into a plurality of intermediate code files with a suffix “.obj” by using the compiler. After compiling the source code of the functional module, it needs to use the linker to link process the plurality of intermediate code files with a suffix “.obj”, and a file with a suffix “.pvm” is finally generated.

In step 206, the plurality of intermediate files are link processed to generate an object file.

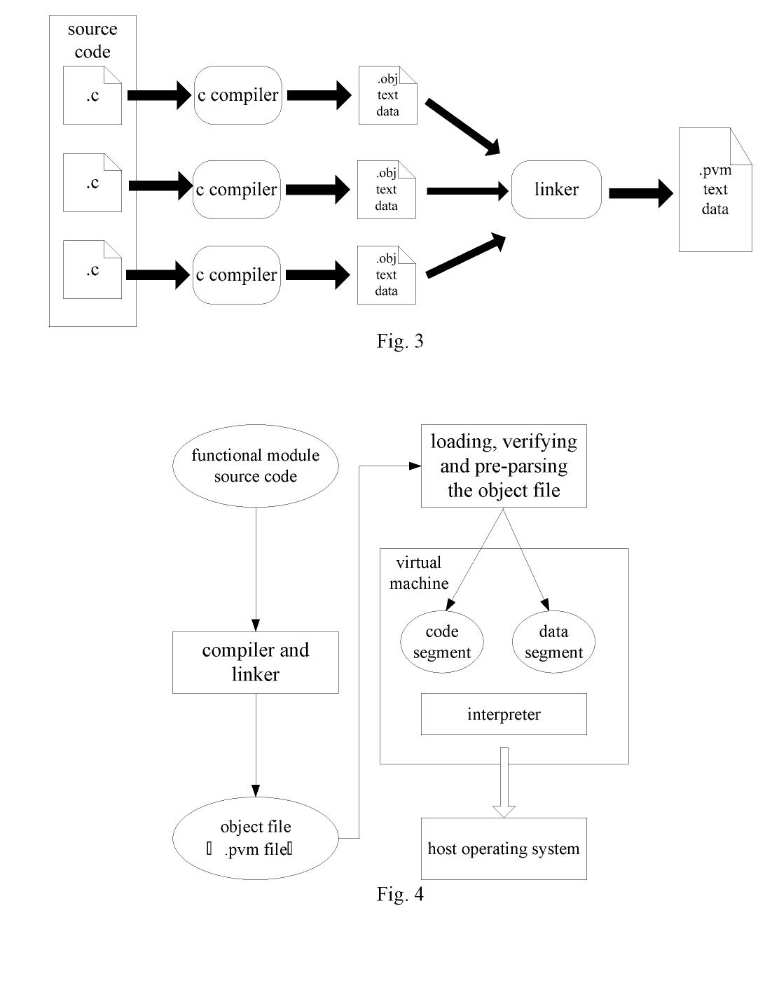

In the embodiment, the intermediate files are link processed by using the linker supporting the C language virtual machine to generate an object file; wherein the linker is a program configured to link one or more files generated by the compiler or assembler. Particularly, the linker is used to link the intermediate files compiled by the compiler to generate a .pvm file, where the .pvm file is composed of the bytecode recognizable by the virtual machine, and is not an executable file. An application program cannot call and execute the .pvm file. Referring to FIG. 3, in an embodiment, a schematic diagram of compiling and linking the source code to generate the object file is shown. Particularly, the standard C code is firstly compiled to generate the intermediate code files with suffix “.obj”, and then the plurality of intermediate code files is linked to generate an object file with a suffix “. pvm”.

In step 208, the object file is loaded.

In the embodiment, after using the compiler and the linker supporting the virtual machine to compile and link the source code of the functional module to generate an object file, the object file is loaded by using the virtual machine developed by the C language. In an embodiment, for loading the object file by the virtual machine, it firstly needs to identify the file identifier of the object file, which is used to identify that the object file is generated by the compiler and the linker supporting the virtual machine, which prevents from maliciously counterfeiting the .pvm file. That is to say, any file of which the suffix is changed into .pvm cannot be a functional module cross platforms. Particularly, the file identifier is represented by a MAGIC value, generated by the compiler, and subsequently verified by the interpreter in the virtual machine.

In step 110, a memory space is allocated to a bytecode in the object file and the bytecode is divided into a code segment and a data segment running in the memory space.

In the embodiment, the running principle of the program is: a code program is compiled into binary bytecodes and then run in any operating system. The operating system needs to allocate a process (memory) space for the program, and these binary bytecodes are divided into the code segment and the data segment to be allocated in the process control for running; wherein the data segment refers to a memory area configured to store the global variables that have been initialized in the program, which belongs to the static memory allocation. The code segment refers to a memory area configured to store the program execution codes. In other words, the code segment is equivalent to the instructions, and the data segment is equivalent to the data information.

In the embodiment, after the virtual machine loads the object file, the object file is pre-parsed firstly, and the data segment and the code segment in which the object file is run are virtualized in the memory space in which the virtual machine is run. Particularly, the interpreter in the virtual machine is used to pre-parse the object file, that is to say, the memory space is allocated for the bytecodes in the object file in the process of the virtual machine, and the bytecodes are divided into the code segment and the data segment running in the memory space. In this way, when the application program in the terminal wants to call the API (Application Programming Interface) function in the functional module (object file), it can initiate the call operation by the external interface of the virtual machine. After the interpreter in the virtual machine receives the call command, it will parse the command and then call the corresponding API function in the functional module. The process that the interpreter calls the corresponding API function in the functional module is a process that the code segment is allocated and interpreted and data is calculated. At the same time, when the functional module needs to call the function of the host system, the function of the host system can be indirectly called by the system call mechanism of the virtual machine.

In the embodiment, the source code of the functional module is obtained, and the source code of the functional module is the standard C code; the source code is compiled to generate a plurality of intermediate files; the plurality of intermediate files are link processed to generate the object file; the object file is loaded; the memory space is allocated for the bytecode in the object file, and the bytecode is divided into the code segment and the data segment running in the memory space. The method implements isolation between the functional module and the platform during the whole process, which can implement operation of a functional module cross platforms without any modification of the functional module, so that the operation is simple. Further, because the C language belongs to a relatively basic and original programming language, the hardware can be directly operated, the machine code can be generated efficiently. the C language can directly access the memory by using the pointer. Compared to the virtual machines developed by some high level programming languages (for example, the Java virtual machine), the virtual machine developed by using the C language does not have much intermediate layer scheduling, and has a higher execution efficiency.

Referring to FIG. 4, in an embodiment, a flow chart of operating a functional module across platforms through a virtual machine developed by using the C language is shown. Particularly, implementation of operating a functional module across platforms can be mainly divided into two parts: one is the process of generating the object file, the other is the process that the code segment and the data segment are virtualized in the virtual machine space for the object file.

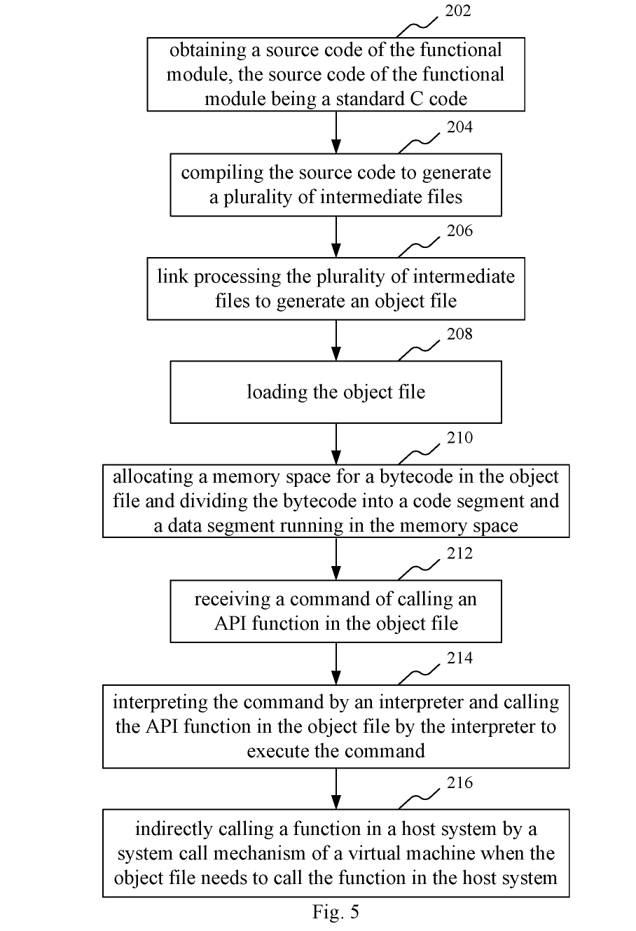

Referring to FIG. 5, in an embodiment, after allocating a memory space for a bytecode in the object file and dividing the bytecode into a code segment and a data segment running in the memory space; the method further includes:

In step 212, a command of calling an API function in the object file is received.

Particularly, the application program in the terminal initiates the command to call the API function of the object file. The virtual machine developed by using the C language receives the command by the external interface. After the interpreter in the virtual machine receives the call command, it will parse the command and then call the corresponding API function in the functional module; wherein the API function: the operating system not only coordinates execution of the application program, memory allocation and system resource management, but also serves as a large service center, calls various services of the service center (each service is a function), help the application program to achieve purposes that windows are opened, graphics are drawn, and peripheral equipments are used. Because objects served by these functions are the application programs, it is called Application Programming Interface, referred to as API function.

In step 214, the command is interpreted by an interpreter and the API function in the object file is called by the interpreter to execute the command.

In the embodiment, after the virtual machine developed by using the C language receives the command of calling the API function of the object file, the command is parsed by the interpreter in the virtual machine, and the API function in the object file is called by the interpreter; wherein, the interpreter is a program that can translate and run the high level programming language line by line directly, that is to say, the interpreter is like a “middleman”, when the program is run, the program has to be converted into another language to be run. Particularly, the process that the application program calls the API function in the functional module is the process that the code segment in the object file is allocated and interpreted and data is calculated by the interpreter.

In step 216, a function in a host system is indirectly called by a system call mechanism of a virtual machine when the object file needs to call the function in the host system.

In the embodiment, when the object file executes the calling instruction of the application program, it is sometimes necessary that the object file further calls the function in the host system to complete the calling instruction of the application. When the object file needs to call the function in the host system, it needs to indirectly call the function in the host system by the system call mechanism of the virtual machine. This is because it needs to isolate the functional module from the platform, the function in the host system cannot be called directly. It needs to perform a packaging operation by the virtual machine, and the system call mechanism in the virtual machine is the means of packaging. Where the virtual machine can be adapted to the host system platform, the application program can call the function in the functional module by the virtual machine, that is to say, isolation of the functional module and the platform is implemented.

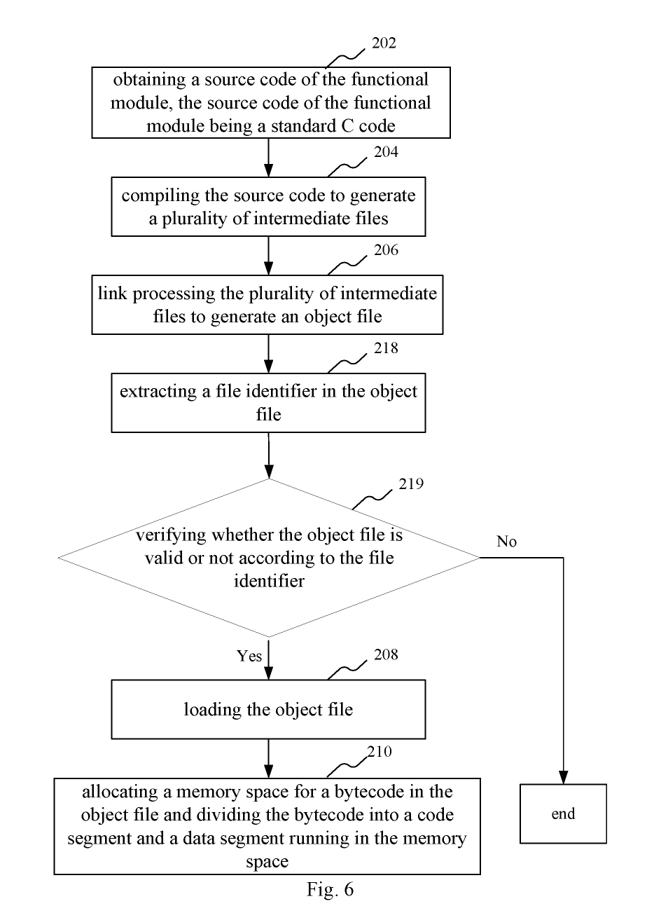

Referring to FIG. 6, in an embodiment, prior to loading the object file, the method further includes:

In step 218, a file identifier in the object file is extracted.

Particularly, the file identifier is a special MAGIC value that is generated when the compiler compiles the source code, and the file identifier is equivalent to a security code that identifies that the object file is compiled by this specific compiler. Before the virtual machine loads the object file, the virtual machine firstly needs to extract the file identifier in the object file, and then verifies the file identifier to prevent from maliciously counterfeiting the object file.

In step 219, the object file is verified whether it is valid or not according to the file identifier; if yes, then go to step 108; if no, then the end.

Particularly, the interpreter in the virtual machine verifies the extracted file identifier, that is to say, the MAGIC value is verified. If verification is passed, it is illustrated that the object file is valid, and the object file is loaded. If verification is not passed, it is illustrated that the PVM file is counterfeited, and the virtual machine does not load the file. The object file is verified by the file identifier, which can effectively prevent from maliciously counterfeiting the PVM file.

In one embodiment, after link processing the plurality of intermediate files to generate the object file; the method further includes: the object file is encrypted by using an RSA encryption algorithm; the RSA encryption algorithm includes a public key and a private key; wherein the object file is signed by using the private key in RSA, and a signature of the object file is verified by using the public key in RSA.

In the embodiment, in order to prevent from falsification, the object file is encrypted by the RSA encryption algorithm after the object file is generated, and the object file is signed by using the private key in the RSA algorithm. When the virtual machine loads the object file, the signature is verified by using the public key in the RSA algorithm.

In one embodiment, the method further includes: an authority of the object file to access a function in a host system is set, so that the object file can only access an open function in the host system through a virtual machine, which forms a sandbox environment.

In the embodiment, the sandbox environment refers to an approach to running an application program in a restricted security environment. This approach is to restrict the authority to access to code of the application program. All modification in the sandbox environment will not cause any loss to the operating system, and it is a safety environment. In the embodiment, in order to create a safety environment, the access authority is set so that the object file can only access the open function in the host system, and it is not allowed to access other functions, which constitutes a safety sandbox environment.

In an embodiment, in order to prevent from disassembly, the instruction code of the virtual machine is disarranged. Particularly, the instruction enumeration of the virtual machine is the sequence beginning from 0, so that it is easily disassembled. In the embodiment, the enumeration instruction is disarranged by changing the algorithm in the enumeration process during the compiler compiles the source code. Meanwhile, the enumeration value of the instruction is disarranged in the interpreter in the same ways, so that the instruction is enumerated without any rules, which can prevent from disassembly.

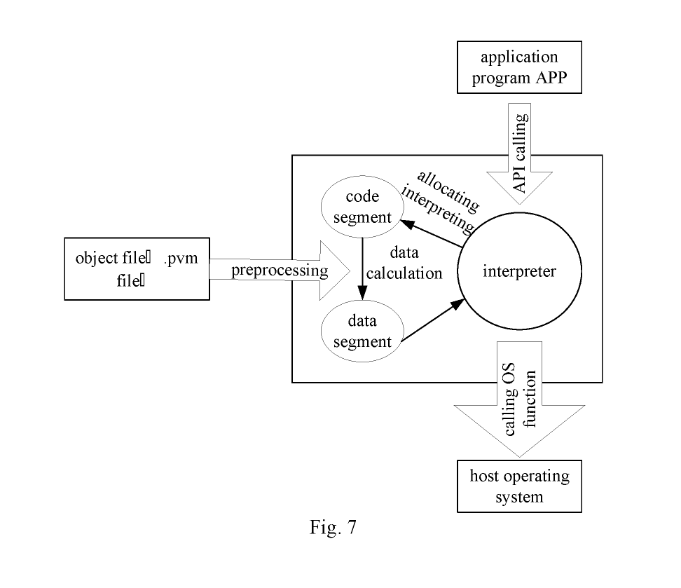

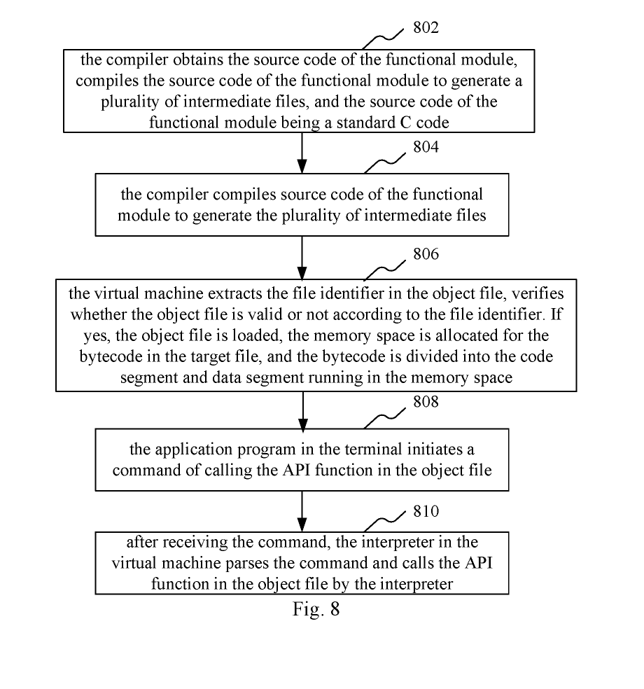

Referring to FIG. 7, in an embodiment, a schematic diagram of the the working process of the interpreter in the virtual machine is shown. Firstly, the interpreter pre-parses the generated object file (the .pvm file), allocates the memory space in the virtual machine to the object file, and divides the bytecode of the object file into the code segment and the data segment. Secondly, the process that the application program APP perform the API call for the object file is actually the process that the interpreter allocates and interprets the code segment. Finally, call of the host operating system by the object file (the functional module) is also performed by calling the open function of OS (Operating System) by the interpreter. Referring to FIG. 8, in an embodiment, a method of operating a specific functional module across platforms is proposed, and the method includes:

In step 802, the compiler obtains the source code of the functional module, compiles the source code of the functional module to generate a plurality of intermediate files, and the source code of the functional module is the standard C code.

In step 804, the linker link processes the plurality of intermediate files to generate an object file.

In step 806, the virtual machine extracts the file identifier in the object file, verifies whether the object file is valid or not according to the file identifier. If yes, the object file is loaded, the memory space is allocated to the bytecode in the object file, and the bytecode is divided into the code segment and data segment running in the memory space.

In step 808, the application program in the terminal initiates a command of calling the API function in the object file.

In step 810, after the command is received, the interpreter in the virtual machine parses the command and calls the API function in the object file by the interpreter.

The above virtual machine is a virtual machine developed by using the C language; wherein the compiler and the linker are the compilers and linkers supporting the C language virtual machine.

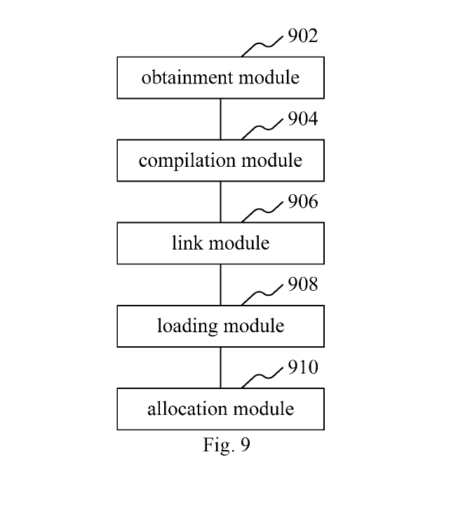

Referring to FIG. 9, in an embodiment, a device of operating a functional module across platforms is proposed, and the device includes:

an obtainment module 902 configured to obtain a source code of the functional module, the source code of the functional module is a standard C code;

a compilation module 904 configured to compile the source code to generate a plurality of intermediate files;

a link module 906 configured to link process the plurality of intermediate files to generate an object file;

a loading module 908 configured to load the object file; and

an allocation module 910 configured to allocate a memory space for a bytecode in the object file and divide the bytecode into a code segment and a data segment running in the memory space.

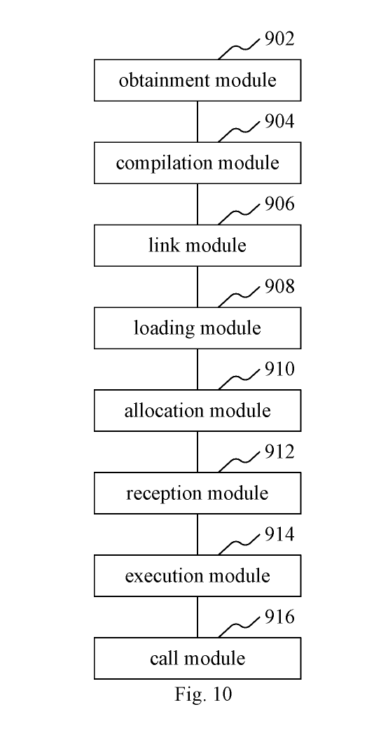

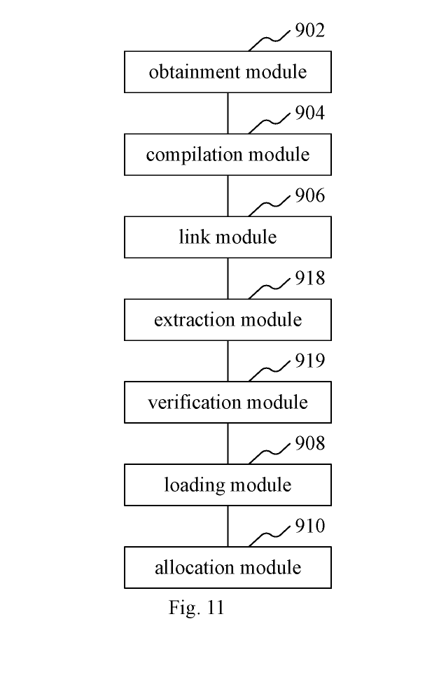

Referring to FIG. 10, in an embodiment, the above device of operating the functional module cross platforms further includes:

a reception module 912 configured to receive a command of calling an API function in the object file;

an execution module 914 configured to parse the command by an interpreter and call the API function in the object file by the interpreter to execute the command; and

a call module 916 configured to indirectly call a function in a host system by a system call mechanism of a virtual machine when the object file needs to call the function in the host system.

Referring to FIG. 11, in an embodiment, the above device of operating the functional module cross platforms further includes:

an extraction module 918 configured to extract a file identifier in the object file; and

a verification module 919 configured to verify whether the object file is valid or not according to the file identifier; if yes, the loading module is informed to load the object file.

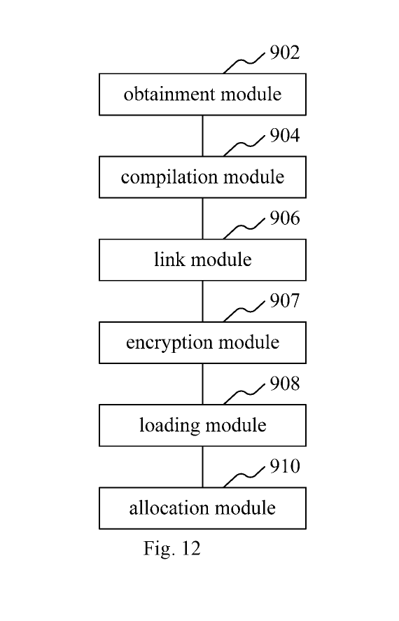

Referring to FIG. 12, in an embodiment, the above device of operating the functional module cross platforms further includes:

an encryption module 907 configured to encrypt the object file by using an RSA encryption algorithm; the RSA encryption algorithm comprises a public key and a private key; wherein the object file is signed by using the private key in RSA, and a signature of the object file is verified by using the public key in RSA.

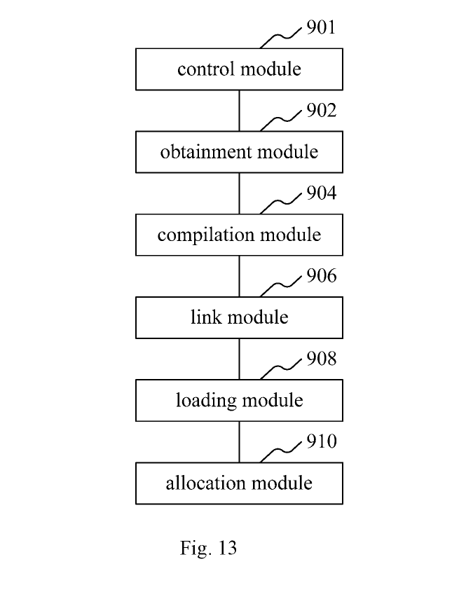

Referring to FIG. 13, in an embodiment, the above device of operating the functional module cross platforms further includes:

a control module 901 configured to control an authority of the object file to access a function in a host system, so that the object file can only access an open function in the host system through a virtual machine.

Various features of the above embodiments can be combined in any manner. For simplicity of description, all possible combinations of various features in the above embodiments are not described. However, these combinations of these features should be regarded in the scope described in the specification as long as they do not contradict with each other.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A method of operating a functional module across platforms, the method comprising the steps of:
obtaining a source code of the functional module, the source code of the functional module being a standard C code;
compiling the source code to generate a plurality of intermediate files;
linking the plurality of intermediate files to generate an object file;
loading the object file; and
allocating a memory space for a bytecode in the object file and dividing the bytecode into a code segment and a data segment running in the memory space.

2. The method of claim 1, characterized in that, after the step of allocating a memory space for the bytecode in the object file and dividing the bytecode into the code segment and the data segment running in the memory space; the method further comprises:
receiving a command of calling an API function in the object file;
interpreting the command by an interpreter, and calling the API function in the object file by the interpreter to execute the command; and
indirectly calling a function in a host system by a system call mechanism of a virtual machine when the object file needs to call the function in the host system.

3. The method of claim 1, characterized in that, prior to the step of loading the object file, the method further comprises:
extracting a file identifier in the object file; and
verifying whether the object file is valid or not according to the file identifier; if yes, loading the object file.

4. The method of claim 1, characterized in that, after the step of link processing the plurality of intermediate files to generate the object file; the method further comprises:
encrypting the object file by using an RSA encryption algorithm; the RSA encryption algorithm comprising a public key and a private key;
signing the object file by using the private key in RSA, and verifying a signature of the object file by using the public key in RSA.

5. The method of claim 1, characterized in that, the method further comprises:
controlling an authority of the object file to access a function in a host system, so that the object file can only access an open function in the host system through a virtual machine.

6. A device of operating a functional module across platforms, the device comprising:
an obtainment module configured to obtain a source code of the functional module, the source code of the functional module being a standard C code;
a compilation module configured to compile the source code to generate a plurality of intermediate files;
a link module configured to link process the plurality of intermediate files to generate an object file;
a loading module configured to load the object file; and
an allocation module configured to allocate a memory space for a bytecode in the object file and divide the bytecode into a code segment and a data segment running in the memory space.

7. The device of claim 6, characterized in that, the device further comprises:
a reception module configured to receive a command of calling an API function in the object file;
an execution module configured to parse the command by an interpreter and call the API function in the object file by the interpreter to execute the command; and
a call module configured to indirectly call a function in a host system by a system call mechanism of a virtual machine when the object file needs to call the function in the host system.

8. The device of claim 6, characterized in that, the device further comprises:
an extraction module configured to extract a file identifier in the object file; and
a verification module configured to verify whether the object file is valid or not according to the file identifier; if yes, the loading module is informed to load the object file.

9. The device of claim 6, characterized in that, the device further comprises:
an encryption module configured to encrypt the object file by using an RSA encryption algorithm; the RSA encryption algorithm comprising a public key and a private key; wherein the object file is signed by using the private key in RSA, and a signature of the object file is verified by using the public key in RSA.

10. The device of claim 1, characterized in that, the device further comprises:
a control module configured to control an authority of the object file to access a function in a host system, so that the object file can only access an open function in the host system through a virtual machine.
